(19) United States
(12) Patent Application Publication
(10) Pub. No.: US 2005/0197869 A1
(43) Pub. Date: Sep. 8, 2005

(54) System for mergers and acquisitions

(76) Inventors: Justin Schaefer, Douglassville, PA (US); Peter Sattler, Blue Bell, PA (US); Michael Whitted, Charlotte, NC (US); Dale Llewellyn, Center Valley, PA (US)

Correspondence Address: BAKER & HOSTETLER LLP;Suite 1100, Washington Square, 1050 Connecticut Avenue, N.W., WASHINGTON, DC, 20036, US

(21) Appl. No.: 10/748,246

(22) Filed: Dec. 31, 2003

(51) Int. Cl. G06F 17/60

(52) U.S. Cl. 705/7

(57) ABSTRACT

A system for mergers and acquisitions includes a reference center for the most updated best practices documents, and a collaboration room featuring areas for the deal team, the functional team or teams, and the integration team, also featuring a data room and a contacts database, all accessible via a simple user interaction model that masks the complexity of the disparate back end systems, using an authentication means so that users only see or edit the deals and data that they are authorized to see or edit.

### FIELD OF THE INVENTION

The present invention relates generally to computer systems. More particularly, the present invention relates to computer systems for managing information related to mergers and acquisitions.

### BACKGROUND OF THE INVENTION

When a company acquires significant assets or other companies, or divests its own assets, due diligence must be performed. This typically involves examining the seller's past dealings and present financial situation, largely through examination of documents provided by the seller. Additionally, when a single company performs a number of these types of transactions, the company culture and best practices can change, and the personnel involved in each transaction are different, because different areas of expertise are necessary for different types of transactions. Also, in the United States, the Internal Revenue Service and other regulatory agencies require strict record retention for mergers, acquisitions, and divestitures.

Due to the huge volume of paper usually associated with these transactions, items can be overlooked by a due diligence team because the paper documents are not properly organized, are not viewed by the party with the level of expertise to understand them, or records are not kept with respect to who viewed which document.

Additionally, a team for a given transaction may contain members who are geographically distant from one another. In an environment where work requires a lot of paper, and paper documents are examined, communication can break down between members of the team because of geography. Also, a company who makes acquiring assets and companies it core competency changes best practices quite often. Company policy is constantly evolving, and communicating that to different members of different deal teams who are in different portions of the world can be a difficult task.

Accordingly, it is desirable to provide a system that integrates the information necessary for mergers and acquisitions in an organized, accessible, and collaborative environment.

### SUMMARY OF THE INVENTION

The foregoing needs are met, to a great extent, by the present invention, wherein in one aspect a system is provided that in some embodiments manages the data and collaboration aspects of one side of a corporate acquisition or divestiture.

In accordance with one aspect of the present invention, an electronic data room is disclosed. The electronic data room contains an electronic reference center wherein data is stored representing best practices for deal due diligence, an electronic digital war room wherein due diligence data is stored and accessed along with due diligence results, and an electronic data repository containing a checklist of due diligence activities. In a preferred embodiment, the electronic reference center also contains data representing an overview of the deal process, a glossary of deal terms, and/or recommended best practices. In a preferred embodiment, the data representing recommended best practices is available to a user in a separated format, wherein best practices for a first area are available to said user separately from best practices for a second area. In a preferred embodiment, the digital war room contains data representing legal and financial findings or documents, data that is reserved for use by at least one functional team, and/or data that is reserved for an integration team, wherein said data in said digital war room relates to integrating a first company or an asset into a second company. In a preferred embodiment, the digital war room also contains data representing a list of milestones to be reached after the conclusion of a deal. In a preferred embodiment, the digital war room also contains a link to said electronic reference center, preferably to reference center data that corresponds to the digital war room data that appears with the link. In a preferred embodiment, the data repository also contains data obtained as a result of a due diligence process, which may include data obtained from a second company. A preferred embodiment of the electronic data room also contains a list of contacts. A preferred embodiment of the electronic data room also contains a means for authenticating entry into said room, which is preferably operable to permit some users to edit a portion of said data, and said authenticating means is also operable to prevent other users from editing said portion of said data. A preferred embodiment of the electronic data room also contains a means for updating the data, and/or a user interface wherein users are given the option of posting messages regarding a particular piece of said data.

In accordance with another aspect of the present invention, a method of storing and providing access to electronic data is disclosed. The method provides an electronic reference center wherein data is stored representing best practices for deal due diligence, an electronic digital war room wherein due diligence data is stored and accessed along with due diligence results, and an electronic data repository containing a checklist of due diligence activities. In a preferred embodiment, the electronic reference center also contains data representing an overview of the deal process, a glossary of deal terms, and/or recommended best practices. In a preferred embodiment, the data representing recommended best practices is available to a user in a separated format, wherein best practices for a first area are available to said user separately from best practices for a second area. In a preferred embodiment, the digital war room contains data representing legal and financial findings or documents, data that is reserved for use by at least one functional team, and/or data that is reserved for an integration team, wherein said data in said digital war room relates to integrating a first company or an asset into a second company. In a preferred embodiment, the digital war room also contains data representing a list of milestones to be reached after the conclusion of a deal. In a preferred embodiment, the digital war room also contains a link to said electronic reference center, preferably to reference center data that corresponds to the digital war room data that appears with the link. In a preferred embodiment, the data repository also contains data obtained as a result of a due diligence process, which may include data obtained from a second company. A preferred embodiment of the method also provides a list of contacts. A preferred embodiment of the method also contains the step of authenticating entry into said room, and the step of permitting some users to edit a portion of said data, and preventing other users from editing the same portion of the data. A preferred embodiment of the electronic data room also allows users to update the data, and provides a user interface wherein users are given the option of posting messages regarding a particular piece of said data.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an architectural view illustrating a preferred embodiment of one aspect of the electronic data room.

FIG. 2 is an architectural view illustrating a preferred embodiment of another aspect of the electronic data room.

FIGS. 3A-3F represent a flowchart illustrating steps that may be followed in accordance with one embodiment of the method or process.

### DETAILED DESCRIPTION

The invention will now be described with reference to the drawing figures, in which like reference numerals refer to like elements throughout. An embodiment in accordance with the present invention provides a digital data center in which members of a deal team can perform due diligence in a streamlined manner, and in accordance with the company's best practices and other standards.

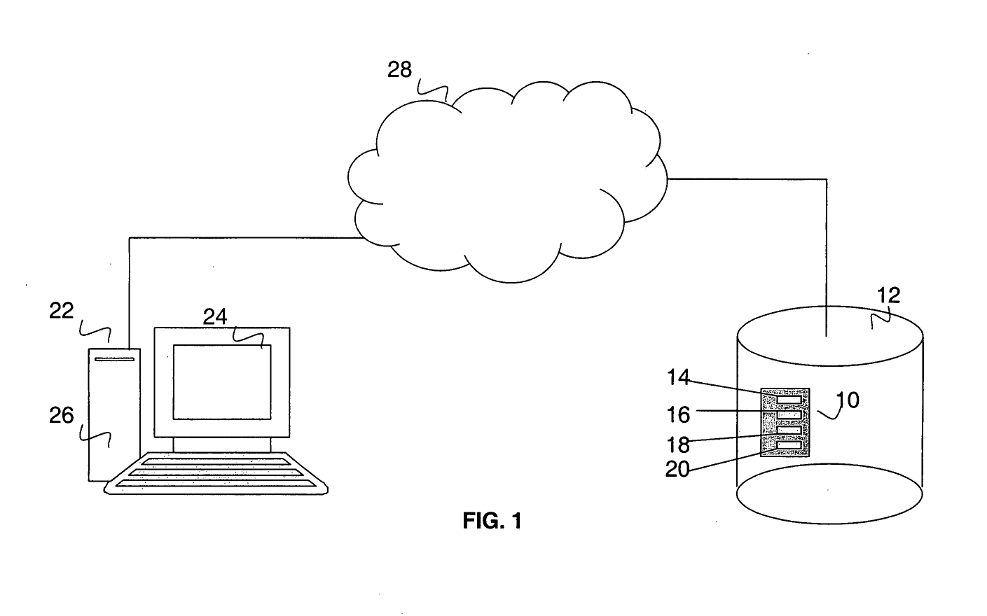

An embodiment of the present inventive system is illustrated in FIG. 1, which will be called the Reference Center for purposes of easy reference only. The Reference Center is a data repository wherein participants in mergers and acquisitions can store, create, and annotate documents online. The Reference Center is implemented using a public folder hierarchy. In a preferred embodiment, the public folders are organized and implemented using Lotus Notes by Lotus Software in Cambridge, Mass. The public folders can be stored in a database 10 stored in a storage medium 12. In a preferred embodiment, the folders contain documents about a particular topic related to mergers and acquisitions. The folders in the system can include documents containing information regarding an overview of the merger and acquisition process 14, and further definition of the merger and acquisition process 16. Folders could also include a glossary of terms related to mergers and acquisitions 18, because different people may be involved from deal to deal, and might not be familiar with the terminology. Folders could also include information about best practices by functional area 20. These would delineate, for those unfamiliar with the general process of making a deal, the company's opinion regarding a preferred way to carry out a merger or an acquisition.

People, or users, can access the system from a personal computer 22, or other network-enabled device having a screen 24 or other display apparatus. A preferred embodiment allows a user to access data from the system while the network-enabled device 22 is not connected to the network 28, because the network-enabled device 22 had previously downloaded some of the content while it was connected to the network 28. The system has a simple user interface implemented in computer code stored either in the storage medium 12, a second storage medium 26 inside the computer 22, or a third storage medium. Also, the system may contain links to sources outside the system, such as on the Internet, or in other knowledge bases inside the company. In a preferred embodiment, the user interface code is written in a language capable of being interpreted with software known as a web browser. Examples of such a language include Hypertext Markup Language (“HTML”), JavaScript, and Extensible Markup Language (“XML”). An alternate embodiment of the system is not “browser-based,” but, instead, implemented in a standalone application that is resident on the computer 22 or some other computer to which the computer 22 has access. Said code is stored in the storage medium 12, or in a third storage medium. The user accesses the user interface implemented by the user interface code through a distributed network 28, such as the Internet, that connects the storage medium containing the user interface code to the computers 22 used by the users.

All of these documents can be edited by members of the deal team, subject to access control mechanisms for each individual team member. For example, a deal team can contain members that are responsible for changing best practices documents, and other members that are not permitted to change best practices documents, but may or must view them. Each member has read or write privileges on the document or documents as appropriate. Similar privileges can be used for the overview, definition, and glossary documents, and the contacts document or database. Different members of a particular team may have access to certain of these documents, either to change them or only to read them.

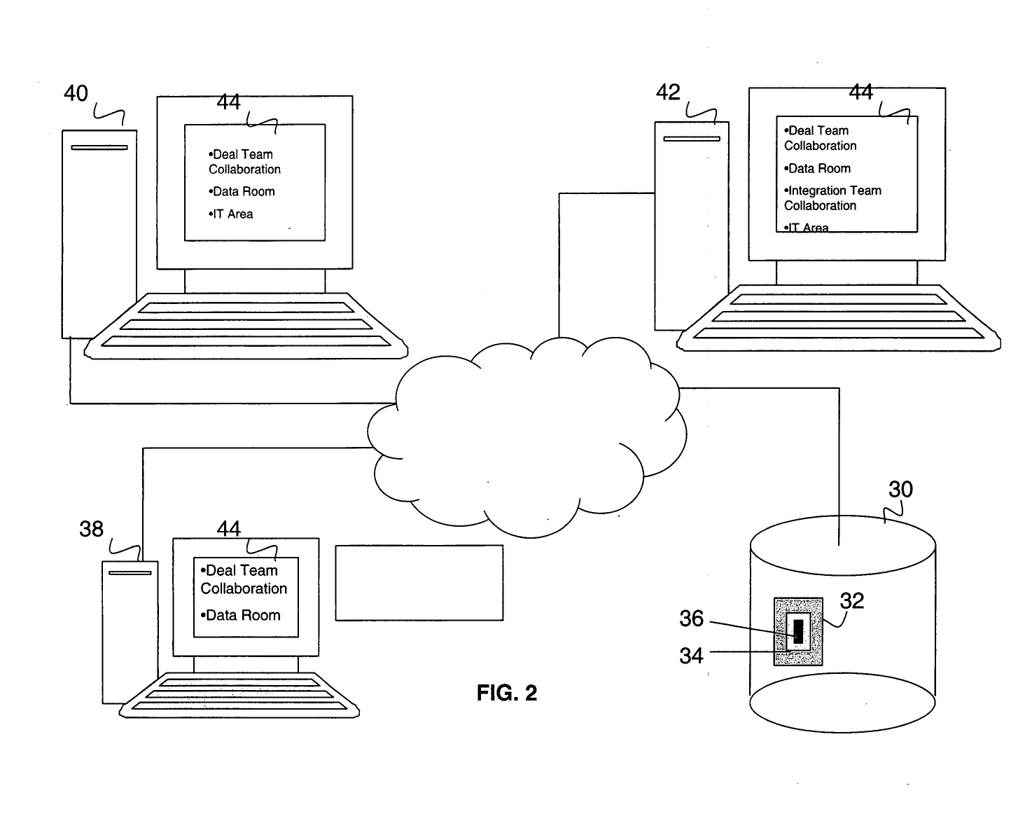

Turning now to FIG. 2, where an embodiment of a collaborative environment, which can be called the “Digital War Room,” for reference, is shown. The Digital War Room allows for synchronous and asynchronous collaboration between multiple teams that may or may not have overlapping members. In a preferred embodiment, there is a separate “Digital War Room” for each pending and/or completed deal, which can be configured with security and acquisition manager information specific to the deal.

Like the Reference Center, the Digital War Room includes a storage medium 30 that stores the information 32 to which the users will have access, as well as the code implementing the system itself 34, including the user interface code 36. Although one storage medium 30 is pictured, the reader will understand that a plurality of storage media can be used, which do not necessarily have to exist in the same physical location as each other. The storage medium 30 may be the same as the storage medium 14 in FIG. 1, but also may be a separate storage medium. In this drawing example, three user terminals, or computers, are depicted 38, 40, and 42. The user terminals 38 40 42, and the storage medium 30 (which may reside inside another computer, such as a server), are connected to each other through a distributed network such as the Internet, a Local Area Network, or a Private Network.

The first team for which the Digital War Room facilitates collaboration is the Deal Team. The Deal Team Collaboration area has specific repositories for Legal, Financial, and Due Diligence Findings. The financial and due diligence findings can include data about the target company, including original documents from the target company. These original documents can also be summarized into new documents containing financial information, and the impressions and opinions of the Deal Team, including information affecting the overall value of the acquisition, and the probability of events, including revenue streams, success of specific projects, or growth.

The legal findings can also include original documents from the target company, or summary documents created by legally trained members of the deal team. By protecting legal information and giving read access only to those who need it, the Digital War Room aids the acquiring company in maintaining the attorney-client privilege, and in abiding by any non-disclosure agreements relevant to the potential deal. Having the deal documents accessible from a unified interface allows the deal team to have access only to the most current information at any given time. The Deal Team Collaboration area also has project management functionality imbedded into it. Here, the manager of the deal project can plan out the process of the particular deal, and assign tasks to or make requests of the other Deal Team members. The Deal Team Collaboration area also has links to the Reference Center for any non-deal-specific data or documents that may be relevant to the particular deal. Thus, from the Deal Team Collaboration area, the Deal Team has immediate access to the latest Best Practices guides and glossaries.

The Digital War Room can also be used for synchronous and asynchronous collaboration by one or more Functional Teams. The Functional Team Collaboration area allows for collaboration around a larger subset of people from the acquiring company in a functional manner. While the Deal Team may be the actual negotiators and people supporting them, the Functional Team may contain others, including people both internal and external to the acquiring company, who can store, comment, and collaborate on a wider range of documents regarding the deal. These documents can include not only the financial, legal, and due diligence documents contained in the Deal Team Collaboration area, but also strategic documents.

The Digital War Room can be used for collaboration between members of an Integration Team. Integration is the process by which the acquired assets or companies become a part of the acquiring company. For a particular deal, the Integration team will require access to different data than the Deal Team or the functional team. The Integration Team collaboration area can contain lists of milestones that need to be reached as part of the integration process and target dates for completion of those milestones, and a checklist to track integration progress after the deal has closed. Additionally, the Integration Team collaboration area can include some pre-deal milestones, including progress at time intervals before the close. For example, it can contain milestones for 90 days before the deal closes, and other milestones for 30 days before the deal closes. The Integration Team collaboration area can provide links to web services for processes that the acquiring company requires after the conclusion of every deal.

The Digital War Room also contains a data room. The first primary function of the Data Room is to make a custom checklist available to the users of the Digital War Room. This custom checklist can be implemented using a spreadsheet program, like Microsoft Excel from Microsoft Corp. in Redmond, Wash. In one embodiment, a master checklist will be implemented using Visual Basic and Microsoft Excel. Then a new Digital War Room is created for a new deal, a new checklist is created from the master, by entering the master and selecting each item from the master that should be included in the checklist for the deal being created. Another embodiment of the checklist can be implemented using a custom developed database from Oracle Corporation, and the J2EE programming language from Sun Microsystems, Inc. The custom checklist will contain a list of all necessary or recommended deal-related tasks before the deal can be approved, or completed by the acquiring company's senior officials. Included in the list are all of the data points that need to be collected and evaluated from the target company, including accounting and financial information, information about assets and liabilities, and legal information. The data room provides for a repository for storing not only the checklist in its generic form, but also allows those with sufficient security privileges the ability to edit the checklist to insure that the information required from the target company has been obtained, and/or has achieved the standards desired by the acquiring company. A preferred embodiment of the checklist will allow a user to update the master checklist, and the changes to the master checklist will cascade to the checklists for each deal in each Digital War Room. Alternatively, changes to the master checklist could be communicated to a designated person for each deal, for example, via electronic mail. The designated person would then be able to decide whether to implement the change in the deal-specific checklist. Additionally, the data room provides for a repository for storing electronic media received during due diligence activities. Non-electronic printed materials, drawings, etc. can be scanned and stored in the data room. In one embodiment, users from within the target company will be able to access the system and update its contents. Security will be enabled so that the outside users only have access to the appropriate data stores.

In a preferred embodiment, the Digital War Room contains a list of contacts relevant to the deal. Members of the Deal Team, the Integration Team, or the Functional Teams can update their own contact information, and view the contact information of others. Some members of the teams may have access to update or add contacts of others, including contacts within the target company. In a preferred embodiment, the contacts are linked to a central LDAP metadirectory, which will automatically maintain contact information in all Digital War Rooms.

User terminal 38 shows that a user has logged into the system and chosen to enter the Digital War Room for a particular deal to which the system has determined that the user has access. The user who has logged into computer 38 has access to the Deal Team Collaboration Area and the Data Room, but not the Integration Area or any of the Functional Areas. This is shown on the screen 44 of computer 38, where the user only has user interface objects relating to the areas of the Digital War Room to which the system has determined that the user has access. Computer 40 shows that a second user has logged into the system and chosen to enter the Digital War Room for a particular deal to which the system has determined that the second user has access. The second user has access to the Deal Team Collaboration Area, the Data Room, and the Information Technology Functional Team Collaboration Area, but no access to the Integration Team Collaboration Area. This is shown on the screen 44 of the computer 40, which shows only user interface objects relating to the areas of the Digital War Room to which the system has determined that the second user has access. Computer 42 shows that a third user has logged into the system and chosen to enter the Digital War Room for a particular deal to which the system has determined that the third user has access. This user has access to all types areas of the Digital War Room, as shown by user interface objects for the Deal Team Collaboration Area, the Data Room, the Integration Team Collaboration Area, and the Information Technology Functional Team Collaboration Area.

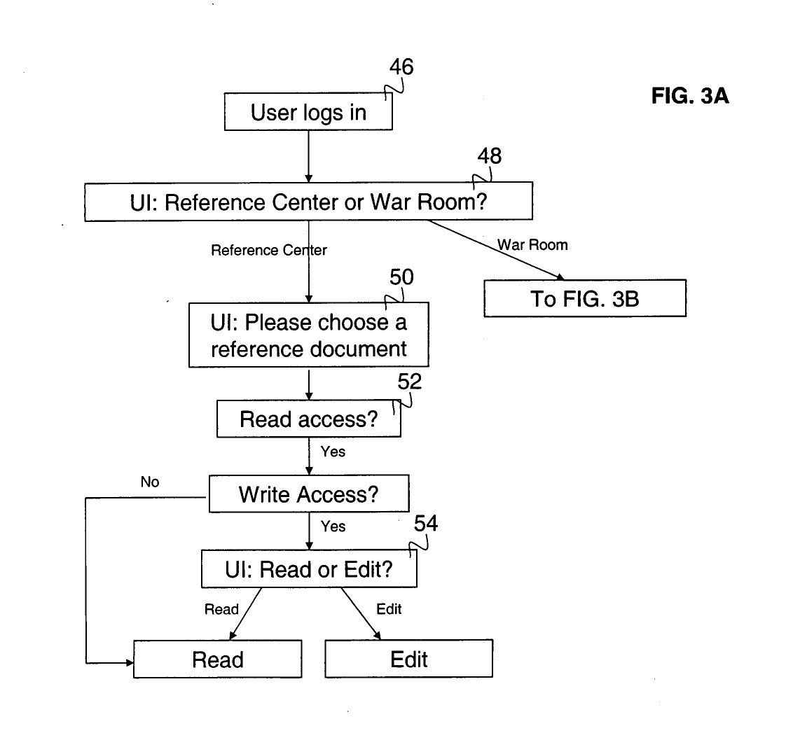

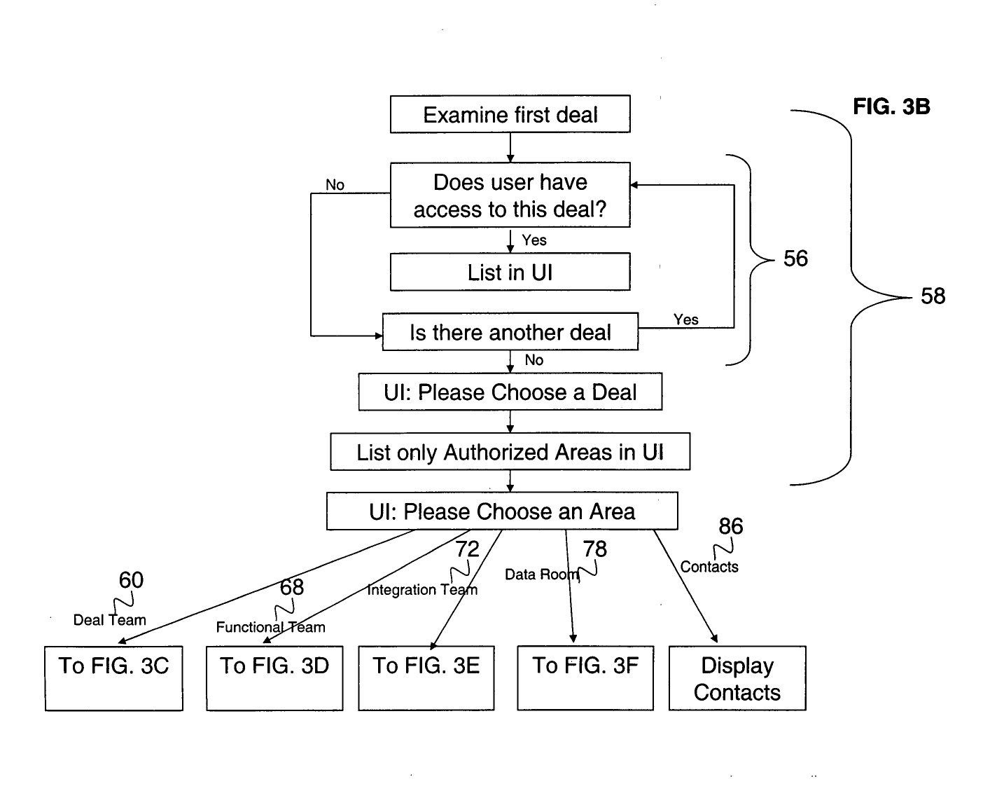

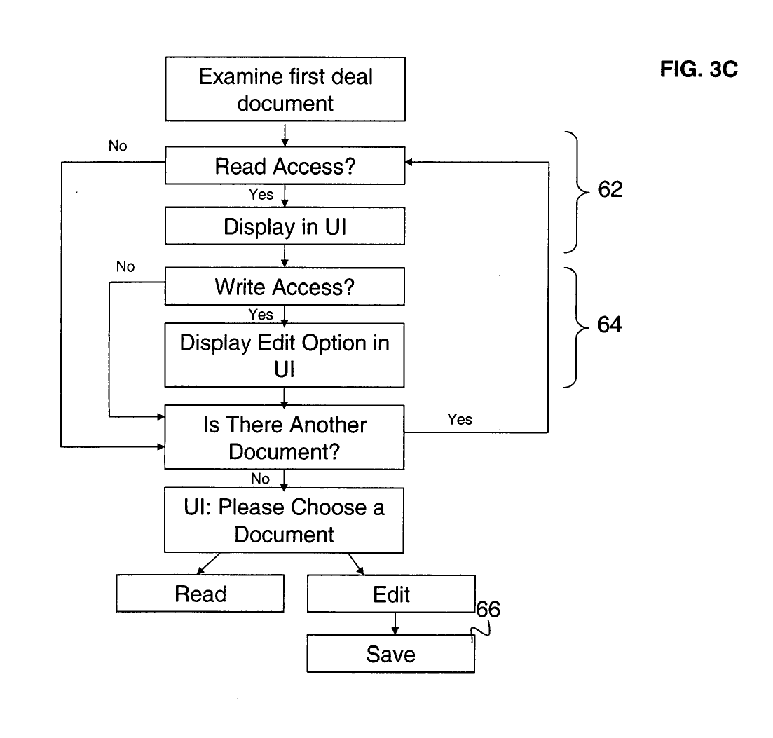

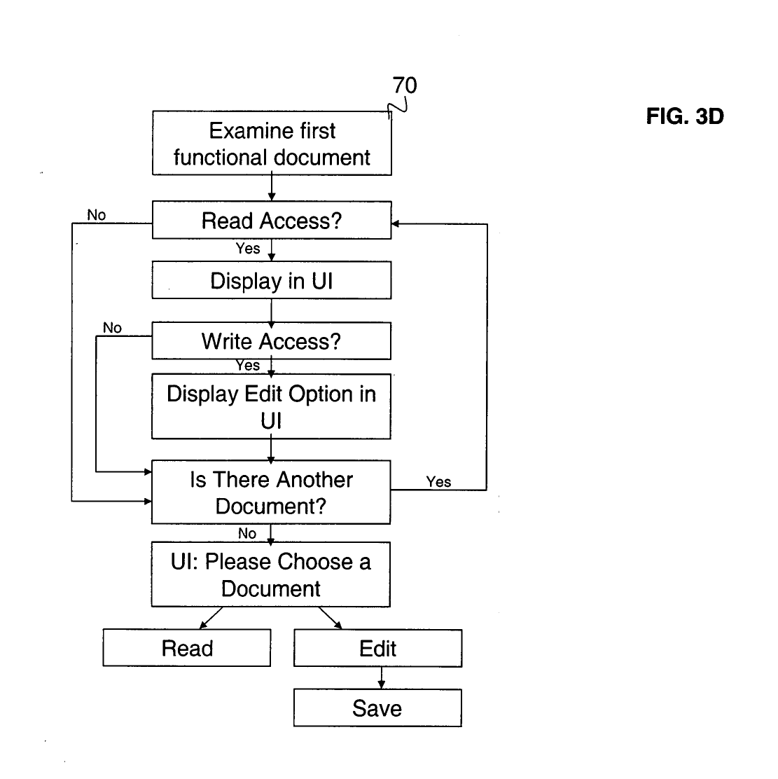

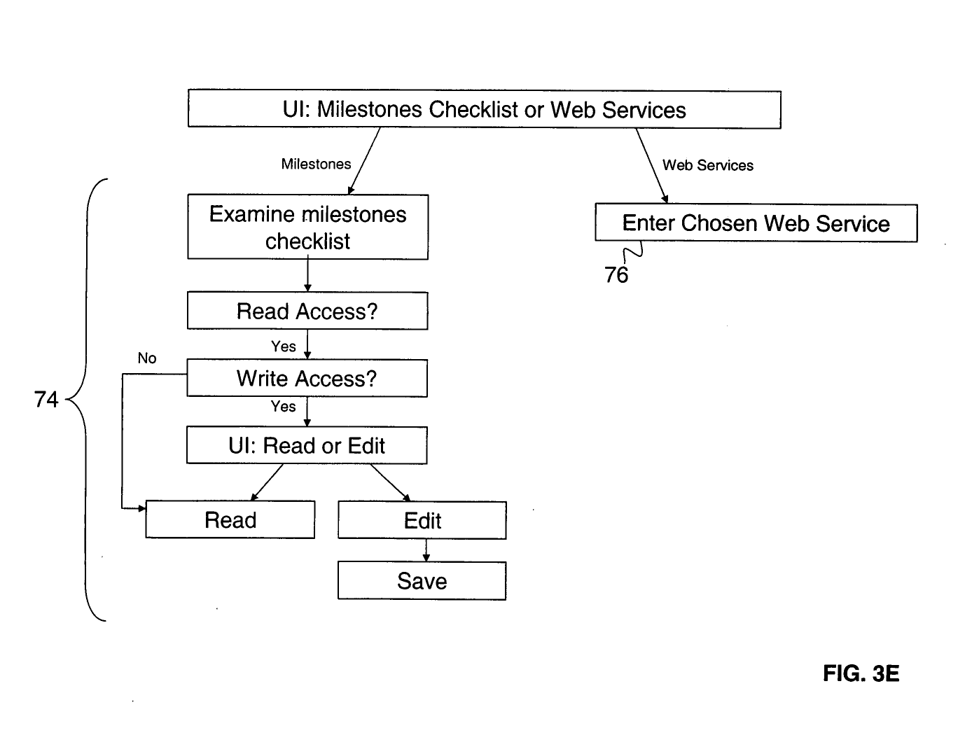

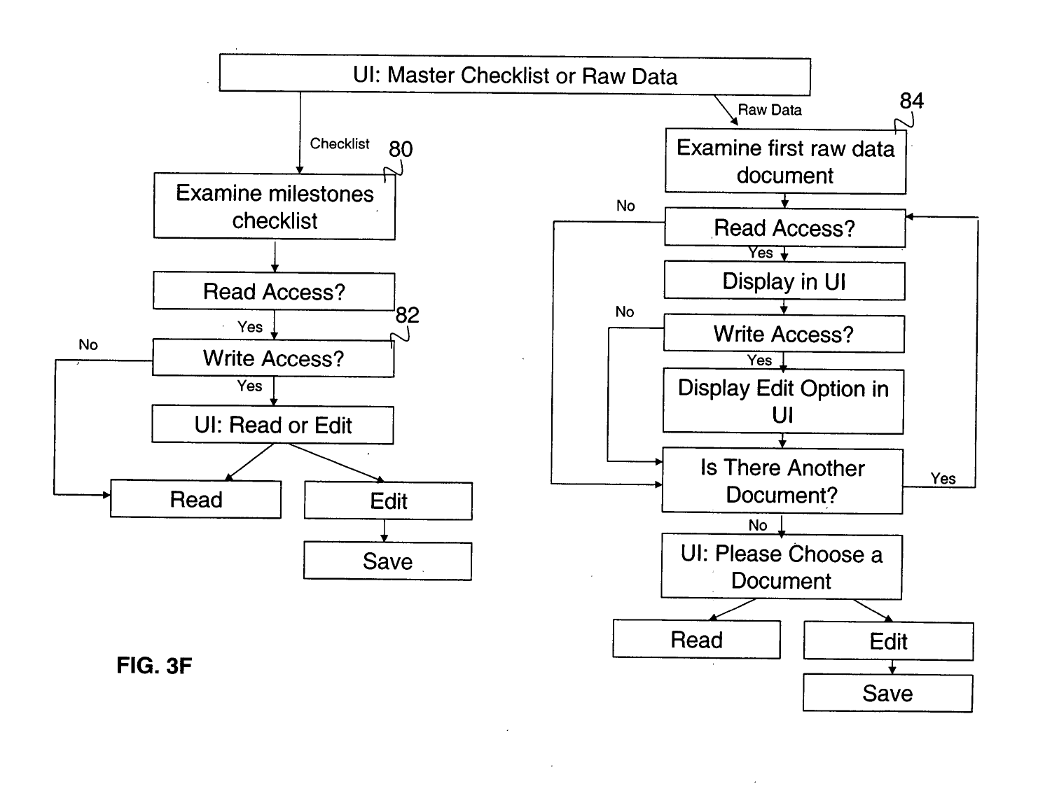

Referring now to FIGS. 3A-3F, an overview of a method for using and implementing the system is shown. When a user launches the system or navigates to the system's main web page, the user is asked for identification, normally in the form of a username and password, or some equivalent authentication method 46. Once the user has authenticated into the system, the user is presented with choices in a simple user interface. In this embodiment, the user may choose to enter the Reference Center, or the Digital War Room 48. If the user chooses the Reference Center, the user is taken to the Reference Center interface 50. There, the user can choose to view the best practices information and other reference materials related to mergers and acquisitions 52. Based on the user's authentication information, the user may or may not be given the right to edit one or more of the best practices documents 54.

If the user chooses to enter the Digital War Room, in this embodiment, the user is given a list of deals to which the user has access to some or all of the rooms within the Digital War Room 56. In an alternate embodiment, each Digital War Room, for each deal, will have a separate location with separate authentication. With this simple portfolio view, the user is able to look at his or her entire deal portfolio on a single page or screen. The list can be generated by examining each of the deals available, and checking if the user's identification is on the list of users permitted to access some or all of the data relevant to the particular deal 58. Alternatively, the deal data, or some portion of it, can be made available to predefined groups of users, in which case the system checks to see if the user is a member of any group to which access to the deal data has been given. Additionally, metrics regarding the deal, for example, its stage of completion, can be displayed in the “dashboard” or portfolio view. Additionally, in a preferred embodiment, the user will be able to view the departments of the company which have approved the deal, and the departments from which approval is pending.

Once the user has been presented with the list of deals to which the user has access, the user may choose a deal, for example, by clicking a hyperlink that points to that deal's Digital War Room. Once “in” the room for the particular deal, the user can choose a number of options to see and edit deal data. The first option is that the user can enter the Deal Team Collaboration Area, by clicking on a hyperlink or icon pointing to that area 60. In that area, the user can browse the financial, legal, and due diligence documents contained in that area. In a preferred embodiment, different documents, or different classes of documents (i.e. financial, legal, and due diligence) will be wrapped in separate security and access controls, so that the acquiring company can allow some users to see certain Digital War Room documents but not others 62. In other words, security at a document level can be implemented and enforced. In a preferred embodiment, the user will only see documents to which the user has at least the right to read.

Additionally, a particular user may have the right to edit one or more documents or document types 64. The user can be given a separate option to choose for the documents to which he has write access. Alternatively, the properly authenticated user can click on the document and have access to edit it from within the user interface after the user has chosen the document. Either way, the user is given access to edit the document directly from the Digital War Room, so the user knows that the document being edited is the most current version of the document. The user will also have the option of saving the document when the user is finished editing it 66. In a preferred embodiment, the user can also provide additional attributes to the document, such as routing it for approval by other team members, edit the document's security attributes, or the user can create a draft version of the document before publishing it. By saving the document using the Digital War Room interface, the user is assured that other users will see the most recent information. By giving the Deal Team the ability to immediately update all of the relevant deal information, allowing for smoother collaboration between Deal Team members.

For the deal that the user has chosen, the user can also choose to enter one or more Functional Team Collaboration Areas with respect to that deal 68. In a preferred embodiment, the user will only see, and have the option to enter, the Collaboration Areas for the Functional Teams of which the user is a member 70. Once the user has entered the Functional Team collaboration area, the user will have the ability to read a wider variety of documents that would not be kept in the core Deal Team Collaboration Area, perhaps because they do not fit into the “financial, legal, or due diligence” categories. These functional teams can contain documents and findings in many different areas of the company, including, but not limited to, human resources, risk management, and information technology. People with each of these disparate disciplines can add to the merger and acquisition process. If each of these functional teams has its own collaboration area, they can better be able to communicate and, it will be easier to craft and implement the goals or requirements of the acquiring company.

The user can also choose to enter the Integration Team Collaboration Area, if the user is authenticated as part of the Integration Team 72. Here, the Integration Team can access and update the integration milestones for the deal, or the master integration checklist 74. Also, the user can take advantage of web services that are important to the integration process 76.

The user can also choose to enter the Data Room associated with the deal 78. Here, the user can view or update the Master Due Diligence Checklist spreadsheet, where the user can make sure all of the required information is being received, and all of the required tasks are being accomplished in the appropriate time frame 80. The checklist items can change if a user with appropriate privileges changes them 82. This gives the users in the Data Room the latest Master Checklist, so that the users can be sure that they are meeting all pre-deal requirements. In a preferred embodiment, as the requirements change, the users in the Data Room for a particular deal will know about them, either through automatic updates to the checklist, or via messages sent to a selected person, who will decide whether the implement the change in the deal-specific checklist. For example, the Master Checklist may have contained certain items when the Data Room for a particular deal was created. Subsequent to that, the Master Checklist changed, reflecting the views of those inside and outside the acquiring company about what the important tasks are. When the Master Checklist changes, the changes are propagated to the particular Checklist for the particular deal, so that when the user examines the checklist for compliance, the user will see the newly added requirements, or will no longer see requirements that have been deleted after the creation of the Checklist for this deal.

In the Data Room, the users will have access to the raw data acquired from the target company as part of the due diligence process 84. A user with appropriate privileges can access all of the electronic data that the target company has provided as part of due diligence. Because the electronic data is easily organized in a simple user interface, the user can easily see what raw data is present, and what raw data is still missing. The Data Room, as a central repository for all of the data, allows the users to see all of the documents to which they have access, or all of the documents that are within a category of documents to which the user has access. Thus, the user has central access to the most up to date raw data from the due diligence process.

Also from the main Digital War Room interface, the user can view a list of contact information for people relevant to the deal 86. The contacts list can contain any combination of internal contacts, contacts within the target company, and outside consultants and other professionals. The contacts information can also contain the identity of the acquiring company's experts on particular areas of mergers and acquisitions. This will allow the deal team to easily contact the company's experts in each of the relevant areas. For example, the contacts could list the contact information for the company's expert on information technology, risk management, or intellectual property.

Although the system is useful to aid with mergers and acquisitions it can also be used, for example, to aid with divestitures, or any business process requiring a high level of interaction or collaboration, including enterprise resource planning (“ERP”) implementation, zero day start, recruitment, or budgeting.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An electronic data room, comprising:
(a) an electronic reference center wherein data is stored representing best practices for deal due diligence;
(b) an electronic digital war room wherein due diligence data is stored and accessed along with due diligence results; and
(c) an electronic data repository containing a checklist of due diligence activities.

2. The electronic data room of claim 1, wherein data is stored in said electronic reference center representing an overview of the deal process.

3. The electronic data room of claim 1 wherein data is stored in said electronic reference center representing a glossary of deal terms.

4. The electronic data room of claim 1 wherein data is stored in said electronic reference center representing recommended best practices.

5. The electronic data room of claim 4 wherein said data representing recommended best practices is available to a user in a separated format, wherein best practices for a first area are available to said user separately from best practices for a second area.

6. The electronic data room of claim 1 wherein data is stored in said digital war room representing at least one of legal and financial findings and legal and financial documents.

7. The electronic data room of claim 1 wherein at least a portion of said data in said digital war room is reserved for use by at least one functional team.

8. The electronic data room of claim 1 wherein at least a portion of said data in said digital war room is reserved for an integration team, wherein said data in said digital war room relates to integrating a first company or an asset into a second company.

9. The electronic data room of claim 1 wherein data is stored in the digital war room representing a list of milestones to be reached after the conclusion of a deal.

10. The electronic data room of claim 1, further comprising a user interface for browsing said data in said digital war room, wherein said user interface comprises a link to said electronic reference center.

11. The electronic data room of claim 10, wherein said link to said electronic reference center is a link to data in said reference center corresponding to the data in said digital war room that appears with said link.

12. The electronic data room of claim 1 wherein said data repository also contains data obtained as a result of a due diligence process.

13. The electronic data room of claim 12 wherein said electronic data room is used by a first company, and said data obtained as a result of a due diligence process was obtained from a second company.

14. The electronic data room of claim 1 further comprising a list of contacts.

15. The electronic data room of claim 1 further comprising a means for authenticating entry into said room.

16. The electronic data room of claim 15, wherein said authenticating means is operable to permit some users to edit a portion of said data, and said authenticating means is also operable to prevent other users from editing said portion of said data.

17. The electronic data room of claim 1 further comprising a means for updating said data.

18. The electronic data room of claim 1 further comprising a user interface wherein users are given the option of posting messages regarding a particular piece of said data.

19. A method of storing and providing access to electronic data, comprising the steps of
(a) providing an electronic reference center wherein data is stored representing best practices for deal due diligence;
(b) providing an electronic digital war room wherein due diligence data is stored and accessed along with due diligence results; and
(c) providing an electronic data repository containing a checklist of due diligence activities.

20. The method of claim 19, wherein data is stored in said electronic reference center representing an overview of the deal process.

21. The method of claim 19 wherein data is stored in said electronic reference center representing a glossary of deal terms.

22. The method of claim 19 wherein data is stored in said electronic reference center representing recommended best practices.

23. The method of claim 22 wherein said data representing recommended best practices is available to a user in a separated format, wherein best practices for a first area are available to said user separately from best practices for a second area.

24. The method of claim 19 wherein data is stored in said digital war room representing at least one of legal and financial findings and legal and financial documents.

25. The method of claim 19 wherein at least a portion of said digital war room is reserved for use by at least one functional team.

26. The method of claim 19 wherein at least a portion of said data in said digital war room is reserved for an integration team, wherein said data in said digital war room relates to integrating a first company or an asset into a second company.

27. The method of claim 19 wherein data is stored in the digital war room representing a list of milestones to be reached after the conclusion of a deal.

28. The method of claim 19, further comprising the step of providing a user interface for browsing said data in said digital war room, wherein said user interface comprises a link to said electronic reference center.

29. The method of claim 28, wherein said link to said electronic reference center is a link to data in said reference center corresponding to the data in said digital war room that appears with said link.

30. The method of claim 19 wherein said data repository also contains data obtained as a result of a due diligence process.

31. The method of claim 19 further comprising the step of providing a list of contacts.

32. The method of claim 19 further comprising the step of authenticating entry into said room.

33. The method of claim 33, further comprising the step of permitting some users to edit a portion of said data, and preventing other users from editing said portion of said data.

34. The method of claim 19 further comprising the step of allowing users to update said data.

35. The method of claim 19 further comprising the step of providing a user interface wherein users are given the option of posting messages regarding a particular piece of said data.
